(19) United States
(12) Patent Application Publication
(10) Pub. No.: US 2004/0204844 A1
(43) Pub. Date: Oct. 14, 2004

(54) Navigational device

(76) Inventor: Yonglong Xu, Hildesheim (DE)

Correspondence Address: KENYON & KENYON, ONE BROADWAY, NEW YORK, NY, 10004, US

(21) Appl. No.: 10/763,902

(22) Filed: Jan. 23, 2004

(30) Foreign Application Priority Data
Jan. 24, 2003 (DE) 10302677.0

(51) Int. Cl. G01C 21/34

(52) U.S. Cl. 701/209; 340/995.19

(57) ABSTRACT

A navigational device, where an input destination is first clearly and unambiguously determined on the basis of a data record stored in the navigational device, and, only then, is this destination transmitted to a central processing unit for purposes of route determination.

### BACKGROUND INFORMATION

Navigational devices for navigating a vehicle in a road network are already known where an instantaneous vehicle position is determined, a destination is input by a user, and a route is determined from the instantaneous vehicle position to the destination. Calculating the route requires inputting the destination in a clear, unambiguous manner. In addition, in order to calculate the route, a geographic position, i.e., a position of the destination in the road network, must be known. For that reason, when a destination is input, a dialog (interactive communication) follows between a user and the navigational device, in order to correct any existing input errors, to define the input more precisely, or to make a selection in the case of ambiguous inputs. For this purpose, navigational devices are known, where both the input, as well as the route calculation are made on the basis of a database also transported in the vehicle. To be able to calculate a route while allowing for the latest changes, it is necessary to continuously update the database. In addition, a speedy route calculation requires substantial computing capacity in the vehicle. For that reason, it is known to transfer the database and/or the route calculation to a central processing unit that is remote from the vehicle and designed as a central processing unit. In this context, a destination is input in the vehicle and is transmitted to the service control point. Since in this case as well, incorrect or ambiguous inputs may exist, a dialog follows between the central processing unit and the navigational device in the vehicle in which queries are communicated to the navigational device, enabling the driver to correct his/her input or make a selection among a plurality of alternatives given. For the duration of the query, a data communications link is needed between the navigational device in the vehicle and the external central processing unit.

### SUMMARY OF THE INVENTION

The navigational device of the present invention has the advantage that a memory unit having stored name designations, particularly in the form of a structured and, preferably, also encoded name index of streets and political administrative units, already exists in the navigational device, so that a destination input by a user is able to be matched directly in the navigational device to the name designations stored there. In this way, the communication of destination data may be limited to the already clearly defined and, as the case may be, encoded destination, which, compared to uncoded destination data, has a smaller data volume. This eliminates the need for a query on the part of the central processing unit. In this way, it is possible to greatly reduce the time required to transmit the destination data to the central processing unit, thereby lowering communications costs for the customer and avoiding possible interference, such as that caused by a communications breakdown in an area with no reception. Since the time required to input the destination is shortened, the user is able to concentrate more on the actual driving. In contrast to a route calculation in the vehicle, the need is eliminated for setting up a processing unit for route calculation and for storing a road network in the vehicle, since the name designations may also be stored without a reference to positions in the road network. A connection between the entered destination data and positions in the road network is first established by the central processing unit. In this way, the road network data in the service control point may be updated independently of the stored name designations in the vehicle, as long as no changes in the name designations or their codes are made in the process. In the case that the name designations and/or their codes are changed following a database update, the user is notified, for example, by brief messages, e-mails and/or status messages from his/her account at a service provider, and, by request, the name designations, inclusive of their codes, are newly generated and transmitted to the navigational device.

It is especially beneficial to provide a data medium drive for accommodating a data medium having the stored name data, enabling these data to be simply exchanged and updated. Storing the data on a data medium makes it possible for the user to select the appropriate name designations from his/her home computer, for example via an Internet portal of a service provider, and to transfer them to the data medium at the computer. The stored name data on the data carrier may then be loaded onto the internal memory unit of the navigational device. In this way, the costs for cellular radio transmission may be avoided.

In addition, it is advantageous to select name designations or groups of name designations and to transmit them to the navigational device. In this way, supplementary or specific, selected name designations may be transmitted to the navigational device, even, for example, while underway. For example, if a user of the navigational device is driving in a region for which he/she has not stored any name designations in the memory unit, he/she may feed these, preferably via a cellular radio interface or via a data network of the navigational device.

It is particularly advantageous to provide designations of place names or roads for the input. Names of other establishments, such as restaurants, museums, public institutions or persons may also be stored.

In addition, it is advantageous to transmit the destinations using compressed and/or encoded data because it is possible in this way to reduce the transmitted data volume.

It is also advantageous for a connection, in particular a cellular radio connection, to first be established between the navigational device and the central processing unit when the destination has been clearly and unambiguously input. This makes it possible to economize on other connection costs.

Storing the name designations on a personal basis enables, on the one hand, the data protection to be ensured and, on the other hand, simplifies the search expenditure, as well as automatic correction of input destinations.

### BRIEF DESCRIPTION OF THE DRAWINGS

FIG. 1 shows a schematic representation of a navigational device according to the present invention in conjunction with a central processing unit and a computer unit.

FIG. 2 shows a process sequence according to the present invention for using the navigational device.

FIG. 3 shows a first detail of the process sequence with respect to the selection of the name designations stored in the memory unit and/or in a data medium of the navigational device.

FIG. 4 shows another detail of the process sequence of the present invention with respect to inputting and determining the designation.

FIG. 5 shows an exemplary embodiment of a form of storing the name designations in the memory unit and/or in a data medium of the navigational device of the present invention.

### DETAILED DESCRIPTION

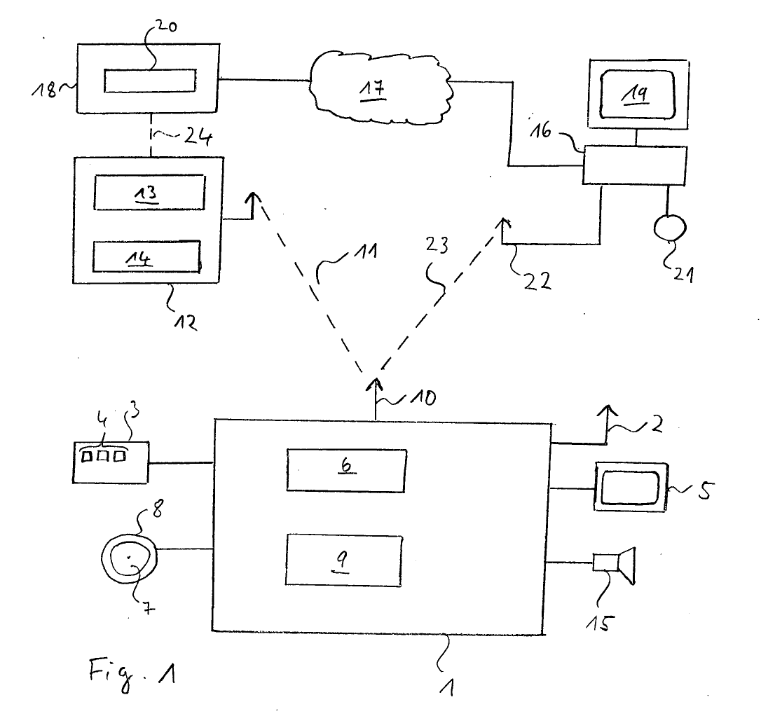

The navigational device according to the present invention may be used for navigating any vehicles at all. Advantageous, in particular, is the use for navigating a motor vehicle in a road network. FIG. 1 shows a navigational device 1 which is situated in a motor vehicle. Navigational device 1 has a position finding device 2 for determining the current vehicle position, for example a satellite-based position-finding device, in particular a GPS (global positioning system). In addition, navigational device 1 is linked to a control unit 3, on which keys 4 are provided for inputting text and/or for making a selection from a displayed list. A display unit 5 is used as a screen on which text input via control unit 3 is displayed, as are lists or other selection fields for selecting a destination. A computing device 6 of navigational device 1 is used to match text information input via control unit 3, with stored name designations. In a first exemplary embodiment, the name designations are stored on a data medium 7 which is inserted in a data medium drive 8 connected to navigational device 1. Data medium 7 is preferably designed as a magnetic and/or optical storage medium, for example as a CD-ROM. In another exemplary embodiment, the name designations are stored in a memory 9 which is integrated in navigational device 1. In another specific embodiment, both data medium 7, as well as memory 9 may be provided as a memory unit for storing name designations.

By accessing memory units 7, 9, computing device 6 corrects the input made via control unit 3 in accordance with a predefined correction instruction. In response to an input that is not clear or that is ambiguous, a dialog is started via display unit 5 with the user in that he/she is offered a selection menu for making a clear, unambiguous selection of a destination. If the destination is clearly defined, a first cellular radio connection 11 to a central processing unit 12 is established via a cellular radio interface 10 of navigational device 1. Via cellular radio connection 11, both the active vehicle position ascertained by position-finding device 2, as well as the destination ascertained by computing device 6 are transmitted to central processing unit 12. Central processing unit 12 has a processing unit 13 which, by accessing a database 14, determines a route from the active vehicle position to the communicated destination. An allocation (correspondence) of the active vehicle position and the destination to positions in the road network is stored in the database. In addition, up-to-date information, for example on road or traffic conditions, may be stored in database 14, to be considered as well in the route calculation. The ascertained route is subsequently transmitted by central processing unit 12 via cellular radio interface 10 back to navigational device 1. The route is at least partially shown in display unit 5, and driving instructions are output to a user via display unit 5, as well as via a loudspeaker unit 15, preferably in dependence upon the specific, active vehicle position, until the desired destination is reached. The name designations may be fed to the navigational device via a data medium 7 that is commercially available. However, it is also possible for the data to be compiled on a user-specific basis. For this purpose, a processing unit 16 is linked via a data network 17, for example the Internet, to a service provider 18. Service provider 18 provides a selection mask via data network 17 that is transmitted to processing unit 16 and displayed in display unit 19. A user may now transmit name designations ordered by geographic regions, from a memory 20 via data network 17 to processing unit 16. In a first embodiment, the data to be transmitted are selected by geographic region, for example by country, such as Germany or France, or by areas, such as “Alps”, or in accordance with other criteria, such as restaurants or attractions. In addition, data pertaining to names may also be transmitted, for example the names and/or numbers of people to whom telephone lines are assigned. A position in the road network may subsequently be assigned by central processing unit 12 to a position in the road network. In addition, it is possible for other data records to be generated by the user himself/herself using processing unit 16.

In a first exemplary embodiment, processing unit 16 has a connected disk drive 21, in which data medium 7 may be inserted and written with the transmitted or entered data. In another exemplary embodiment, processing unit 16 is linked to a radio interface 22, via which a second cellular radio connection 23 is established to the radio interface of navigational device 1, so that data may also be transmitted in this manner to navigational device 1. In another specific embodiment which is not shown in FIG. 1, processing unit 16 may also be designed as a portable computer, which may be linked via a cable connection to navigational device 1, so that the data are transcribed in this way to navigational device 1. In one preferred specific embodiment, the data conveyed from processing unit 16 to navigational device 1 may be personalized in such a way that a user has access to a data record of name data assigned to him/her only after entering an identification. Service provider 18 and central processing unit 12 may be different entities, which are able to work independently of one another, it being necessary, however, for the name designations present in memory 20 to be assigned to the road network. However, service provider 18 and central processing unit 12 may also be implemented as one entity or at least be linked to one another via a data connection 24, which is drawn in with a dotted line.

Particularly when navigational device 1 is first initialized, it is advantageous for data to be supplied using data medium 7. On the other hand, it is beneficial to transmit data via second cellular radio connection 23 when up-dating a data subset or when supplementing already existing data. In this context, disk drive 21 may be designed for writing data media, for example as a so-called CD burner.

FIG. 2 shows a method sequence according to the present invention for operating navigational device 1. In a preliminary transfer step 30, the name designations are transferred to navigational device 1. Upon initial operation of navigational device 1, the destination is entered in an input step 31. In a subsequent transfer step 32, the destination data are conveyed to central processing unit 12. In a calculation step 33, the route is subsequently computed by central processing unit 12 and transmitted in a feedback step 34 back to navigational device 1, which, in a subsequent route guidance step 35, issues driving instructions, for example turn-off instructions for leaving a road just used, at an intersection or an exit, until the input destination is reached.

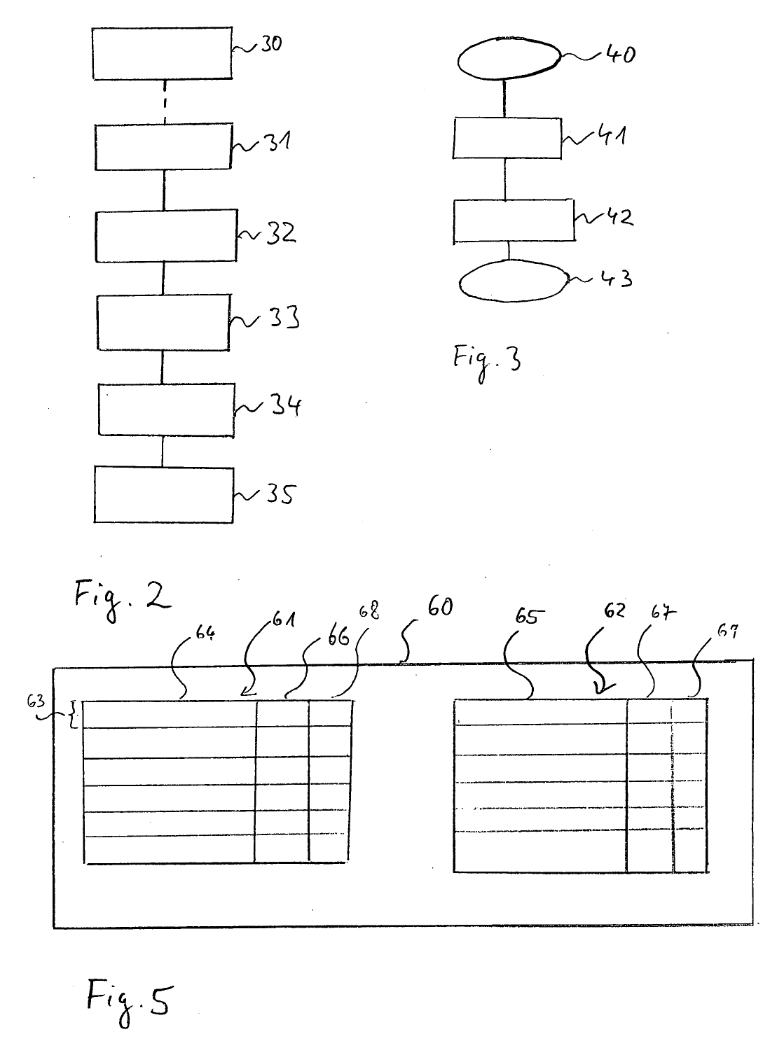

FIG. 3 shows preliminary transfer step 30 in detail. In a starting step 40, processing unit 16 is started by a user, and a connection is established via data network 17 to service provider 18. This is preferably accomplished by establishing an Internet connection and by entering the Internet address of the service provider. If indicated, a user may be identified by a password to be entered. In a subsequent selection step 41, the selection function is initially selected by a user to create an index of name designations. In this function, various regions, such as countries, states, or cities, are offered to the user for selection. At this point, a user may select one or more of these regions. In addition, categories of entities may also be offered, such as hotels, attractions, or public institutions. In a subsequent transfer step 42, the relevant data are extracted from memory 20 of service provider 18, compiled in a data format suitable for navigational device 1, and transmitted via data network 17 to processing unit 16. Moreover, when prompted by a user, these data may be stored under his/her account at service provider 18. To utilize these data, the user may now transfer these data into navigational device 1, in a subsequent loading operation 43, either via second cellular radio connection 23 or, given a larger data volume, transfer the data to a compact disk using disk drive 21 and insert the same into data medium drive 8. In another exemplary embodiment, when prompted by navigational device 1, the data stored at service provider 18 may also be transmitted via a transmission path (not shown) directly via cellular radio interface 10 to navigational device 1.

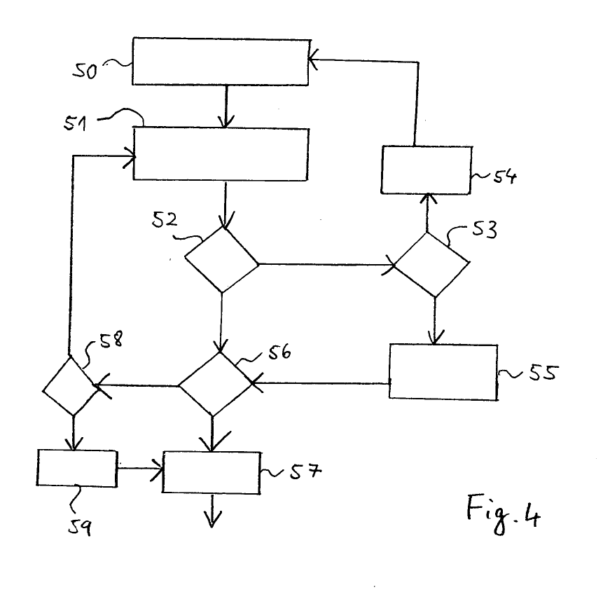

FIG. 4 shows input step 31 in detail. Starting from a starting step 50, following activation of navigational device 1, a user is prompted to input a destination for the navigation. In a subsequent input step 51, one or more text characters are input by control unit 3 into navigational device 1. In other exemplary embodiments, it is also possible to select a destination from a list or input a position via a display unit 5 designed as a touch screen.

Following input step 51, a first verification step 52 checks whether the input character string matches one of the name designations which are stored on data medium 7 and/or in memory 9. If this is not the case, the system branches to a second verification step 53 which checks whether it is possible for the input to be corrected in accordance with a correction instruction. The correction instruction makes it possible, for example, to add individual missing letters or to compensate for inverted letters. If such a correction is not possible, then the system branches to a notification step 54 which notifies the user that there is no name stored in the navigational device for the entry he/she made. The system subsequently branches back to starting step 50, starting from where a user may repeat his/her entry. If it is ascertained, on the other hand, that a correction is possible, then the entry made is corrected in a correction step 55. The system subsequently branches from correction step 55 to a third verification step 56, which is also reached by starting out from first verification step 52, when names are stored with which the character string entered up to that point may be directly and clearly combined. In third verification step 56, it is checked whether the character string entered up to that point already renders possible a clear and unambiguous allocation to a stored name. To this end, if indicated, the clear text entry just made is to be added to the complete designation of the destination.

Subsequently, the system branches further to a defining step 57, in which the thus determined destination is specified as a destination. This is followed by transfer step 32, which is no longer shown in FIG. 4. If a clear allocation is still not determined in third verification step 56, then the system branches further to a fourth verification step 58, which checks whether it is possible to supplement the input with (by proposing) a number of destinations, the number being less than a predefined limit, for example five destinations. If this is the case, the system branches further to a selection step 59, in which, at a maximum, these five destinations are displayed to a user. Of these, he/she may select one and thus define it as the desired destination. There may be various duplicate (identical) place names available for the selection, for example, which are from different regions, however. In addition, the current input may also allow a combination operation with various places, for example, a combination where the input “Karls” becomes “Karlsruhe” or “Karlsbad”. If the number of possible destinations in fourth verification step 58 is still too great, then the system branches back to input step 51, which enables the user to enter other characters.

FIG. 5 shows an exemplary embodiment of a data record 60 of name designations. In the exemplary embodiment shown here, a first data record 61 lists place designations of cities, city districts and townships, and a second data record 62 lists street names. Each row 63, of which only one is marked for the sake of clarity, has one name assigned to it. The place names are entered in a first column 64 of first data record 61, and the names of the street designations are entered in a first column 65 of second data record 62.

Supplemental information on the particular names in first column 64 is stored in a second column 66 of the first data record. This may be information as to whether there is a plurality of locations with these names and in which regions each of these locations is situated. For example, this is information on the country and/or zip code. In a second column 67 of second data record 62, pointers indicating the particular locations of first data record 61 are stored, in which the particular street name occurs. In one preferred specific embodiment, the street name needs to be recorded only once in data record 62, so that a location is then allocated via the pointer stored in second column 67. In a first exemplary embodiment, given a clearly designated destination, the text information stored in first columns 64, 65 is transmitted, if indicated with the necessary supplemental information, to central processing unit 12. In another specific embodiment, however, a third column 68 of the first data record may be stored with a code for the particular location name, and a third column 69 of second data record 62 may be stored with a code for the particular street name. In addition, the supplemental information, such as the country and/or the postal code may also be provided with codes. In place of the text data information, given a clear selection of the destination, the codes stored in third column 68, 69 may also be transmitted, if indicated with the codes of the necessary supplemental information, to central processing unit 12, in order to reduce, in particular, the transmitted data volume. In this case, the central processing unit has a data storage containing information for recovering the relevant text information from the transmitted codes.

In addition, in a third data record (not shown in FIG. 5), establishments, inclusive of corresponding codes, such as hotels and restaurants, may be listed with category details and pointers indicating the particular locations of first data record 61.

What is claimed is:

1. A navigational device comprising:
a control unit;
a memory unit having stored name designations for determining a stored name designation from an input using the control unit to establish a destination;
an interface for transmitting destination data assigned to the determined, stored name designation; and
a central processing unit for receiving the destination data from the interface and for calculating a route to the destination.

2. The navigational device according to claim 1, further comprising a data medium drive for accommodating a data medium having stored name data.

3. The navigational device according to claim 1, wherein one of (a) name designations and (b) a group of name designations are selected and transmitted via an interface to the navigational device.

4. The navigational device according to claim 3, wherein the interface is a radio interface, to at least one of a cellular radio network and a data network.

5. The navigational device according to claim 1, wherein the name designations include at least one of (a) location names, (b) street names and (c) names of institutions.

6. The navigational device according to claim 1, further comprising an encoding unit for at least one of an encoded transmission and a compressed transmission of destination data to the central processing unit.

7. A method for inputting and transmitting a destination, the method comprising:
inputting data for establishing a destination into a navigational device;
from the input data, transmitting specific destination data to a central processing unit; and
matching the input data to a data record of the navigational device prior to transmission in such a way that the transmitted destination data in the central processing unit allows a clear, unambiguous assignment of the transmitted destination data to a position in a road network.

8. The method according to claim 7, wherein the data is transmitted via a radio communications link to the central processing unit.

9. The method according to claim 8, further comprising first establishing the radio communications link from the link to the central processing unit when a determination of the destination data is concluded.

10. The method according to claim 8, further comprising transmitting the data record used for a matching operation via the radio communications link to the navigational device.

11. The method according to claim 10, wherein the radio communications link includes a data network.

12. The method according to claim 7, further comprising assigning the data record used for a matching operation to a user of the navigational device.
